(19) United States
(12) Patent Application Publication
(10) Pub. No.: US 2024/0046201 A1
(43) Pub. Date: Feb. 8, 2024

(54) ASSIGNING SUPPLY TO DEMAND FROM MULTIPLE SOURCES

(71) Applicant: ORACLE INTERNATIONAL CORPORATION, Redwood Shores, CA (US)

(72) Inventor: Randall B. SMITH, Palo Alto, CA (US)

(21) Appl. No.: 17/881,737

(22) Filed: Aug. 5, 2022

(51) Int. Cl. G06Q 10/08; G06Q 30/02

(52) U.S. Cl. CPC G06Q 10/087; G06Q 30/0202

(57) ABSTRACT

Systems, methods, and other embodiments associated with assigning supply to demand from multiple supply sources are described. In one embodiment, a method includes sorting a set of demands by size of demand. A set of assignments between demands belonging to the set of demands and supplies at multiple sources is generated. The set of assignments is generated by, for the demands in ascending order of the size of demand, identifying from among the multiple sources a set of sources having sufficient supply to fill the demand, choosing one source from the set of sources from which to fill the demand, and assigning the demand to be filled from one or more supplies of the one source to form an assignment for the demand in the set of assignments. Supplies are allocated to the demands belonging to the set of demands in accordance with the set of assignments.

### BACKGROUND

Operations management systems may include order fulfillment software that manages the task of matching supplies to demands. The supply to demand assignment problem is trivial where there is sufficient supply to meet all demands. The supply to demand assignment problem becomes a hard problem in computing where there is a limited supply, and one must choose from among ways to fill only some of the demands. In performing the task of supply to demand assignment, it may be desirable to minimize the number of unmet demands in view of insufficient supply to fill all demands. Minimizing unmet demands is a hard problem in computing because the many ways to fill demands grow combinatorially. Available solvers such as Simplex are unable to quickly provide solutions even in simple cases, and in anything beyond simple cases, solvers such as Simplex exhaust compute resources before arriving at a solution.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a multi-source assignment system associated with assigning supply to demand from multiple supply sources.

FIG. 2 illustrates one embodiment of a multi-source assignment method associated with assigning supply to demand from multiple supply sources.

FIG. 3 illustrates one embodiment of multi-source assignment exploration tool associated with assigning supply to demand from multiple supply sources.

FIG. 4 illustrates an example situation in which a flexibility score analysis is performed to assign supply to demand from multiple supply sources.

FIG. 5 illustrates a graph of performance of five multi-source assignment algorithms on sets of example multi-source assignment problems.

FIG. 6 illustrates an embodiment of a computing system configured with the example systems and/or methods disclosed herein.

### DETAILED DESCRIPTION

Systems, methods, and other embodiments are provided herein that provide for assigning supply to demand from multiple supply sources. In one embodiment, a multi-source assignment system selects one source of supplies among multiple sources for fulfillment of a demand. Thus, in one embodiment, the multi-source assignment system chooses a single source at which there are supplies of units of a resource from which units will be taken to satisfy a demand for the units. In one embodiment, the supply for a demand is not gathered from multiple sources.

In one embodiment, the multi-source assignment system enables real-time, what-if exploration of the effect of different configurations of supplies and demands where the demands can be filled from supplies at multiple or alternative sources. For example, in a what-if exploration, a change such as adding or removing supply at a source, changing the priority level of a demand, constraining a demand to be met, constraining it to be unmet, or rescheduling one or more supplies and/or demands can be input or entered, and the ramifications or results of that change are presented rapidly in response to the change, in real-time. Standard solvers such as Simplex are far too slow for the interactive speed used to support what-if explorations so that a user may see the effect of adding or moving supply in various ways. And, where the problem is complex, a standard solver may be unable to even complete the solution because the solver exhausts available compute resources. Even if standard solvers were able to complete the task, they provide only a true optimal solution, whereas the user may be satisfied with a near optimal solution if it enables rapid exploration of alternative situations. Using the multi-source assignment system, the best (near-optimal) solutions may be arrived at in a much shorter time. The rapidity of solutions using the multi-source assignment system enables what-if exploration of changes, and speeds automated assignment between supply source and demand.

In one embodiment, the set of demands is sorted by size of demand. A set of assignments between the demands and supplies at multiple sources is generated. To generate an assignment for a demand, (i) a set of sources having sufficient supply to fill the demand are identified; (ii) one source to fill the demand is chosen from the set of sources; and (iii) the demand is assigned to be filled from supplies of the chosen source. The assignments are generated for the demands in ascending order of the size of demand. The supplies are then allocated to the demands in accordance with the set of assignments.

In one embodiment, as used herein, a “demand” refers to a request that a particular amount of a resource be distributed. In one embodiment, a demand may be characterized by a size or quantity for the amount, a priority in relation to other demands, and a date or time at which the demand is to be filled (also referred to herein as a “time of fulfillment”). A demand may further be marked as constrained to be met or constrained to be unmet. In one embodiment, a demand may be a data structure including values for size, priority, date/time, and the constraints.

In one embodiment, a “supply” as used herein refers to an amount of a resource available for distribution. In one embodiment, a supply may be characterized by a particular size or quantity of amount for the resource that is available for distribution, a source at which the supply is located, and a date or time at which the supply becomes available at the source (also referred to herein as a “time of availability”). In one embodiment, a supply may be a data structure including values for size, source, and date/time.

In one embodiment, an “assignment” as used herein refers to an allocation of a quantity of a particular supply to satisfy, fill, or provide to a particular demand. In one embodiment, an assignment is an additional value included in demand or supply data structures, or an additional data structure relating the supply and demand.

### —Example Multi-Source Assignment System—

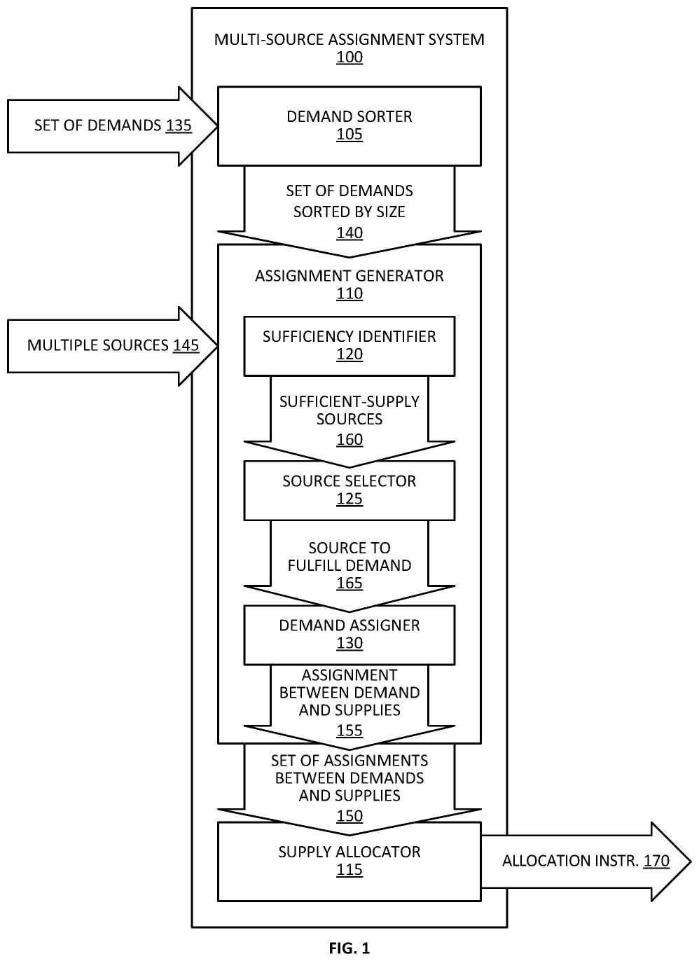

FIG. 1 illustrates one embodiment of a multi-source assignment system 100 associated with assigning supply to demand from multiple supply sources. In one embodiment, Multi-source assignment system 100 generates assignments between demands and supplies at multiple sources where the supply is short and fill rate is to be maximized. Multi-source assignment system 100 includes a demand sorter 105, an assignment generator 110, and a supply allocator 115. Assignment generator 110 further includes a sufficiency identifier 120, a source selector 125, and a demand assigner 130.

In one embodiment, demand sorter 105 is configured to accept and sort a set of demands 135 by size of the demand, thus outputting set of demands sorted by size 140. Assignment generator 110 may also accept input of constraints on individual demands of the set of demands 135 that constrain the demand either to be met or to remain unmet. Where the demands have a priority level, demand sorter 105 may also be configured to sort the set of demands 135 by priority level, and then sort the demands within each priority level by size of the demand, such that set of demands sorted by size 140 is sorted by priority level and sorted by size within each priority level.

In one embodiment, assignment generator 110 is configured to accept set of demands sorted by size 140 and multiple sources 145 with associated supplies, and produce from them a set of assignments between demands and supplies 150. In one embodiment, assignment generator 110 is configured to generate an individual assignment between demand and supply 155 for each demand in set of demands sorted by size 140, one demand at a time. In one embodiment, sufficiency identifier 120 is configured to evaluate multiple sources 145 to identify those of the multiple sources that are sufficient-supply sources 160—that is, sources having sufficient supply to fill the demand. In one embodiment, source selector 125 is configured to choose or select one source to fill the demand 165 from among the set of sufficient-supply sources. In one embodiment, demand assigner 130 is configured to create the assignment between demand and supplies 155 available from the selected source. In one embodiment, assignment generator 110 is configured to add the assignment between demand and supplies 155 to the set of assignments between demands and supplies 150. In one embodiment, assignment generator 110 is configured to repeat this process for each demand in set of demands sorted by size 140. In one embodiment, this produces the set of assignments 150 so that there is one assignment for each demand in the set of the demands with one or more supplies in a single source.

In one embodiment, supply allocator 115 is configured to allocate the supplies to the demands (the demands belonging to the set of demands) in accordance with the set of assignments between the demands and the supplies. In one embodiment, supply allocator 115 transmits an allocation instruction 170 to allocate the supplies to the demands belonging to the set of demands in accordance with the set of assignments. The allocation instruction 170 may be accepted and parsed by an order fulfillment system or order fulfillment tool to cause demands to be filled (for example, provided, shipped, or delivered) from the assigned supplies at a source. The allocation instruction 170 may also be accepted and parsed by an assignment exploration tool for real-time, what-if exploration of effects of various configurations of supplies and demands.

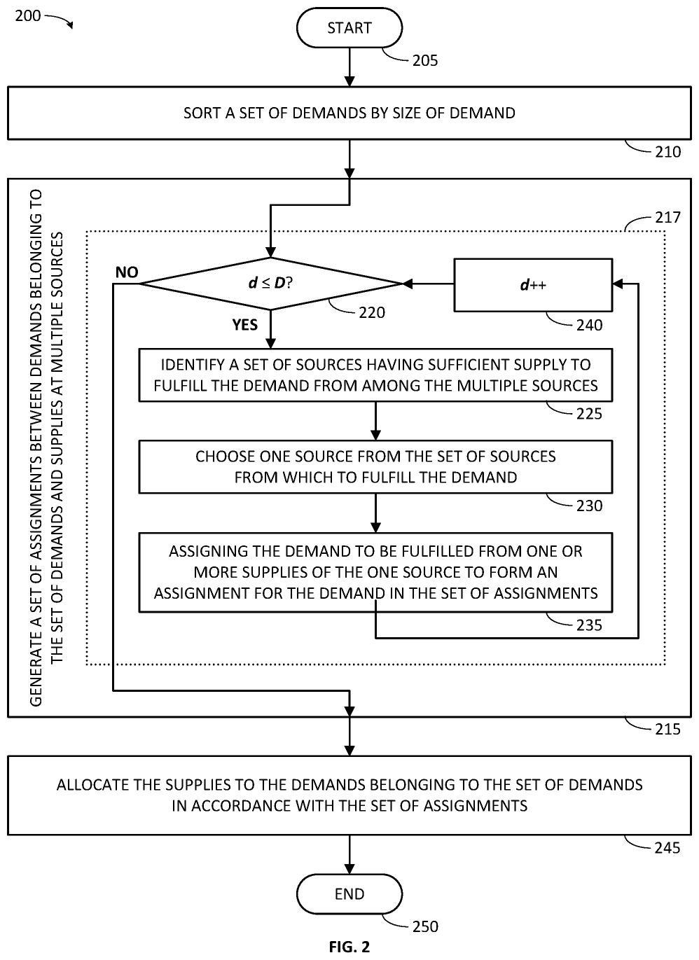

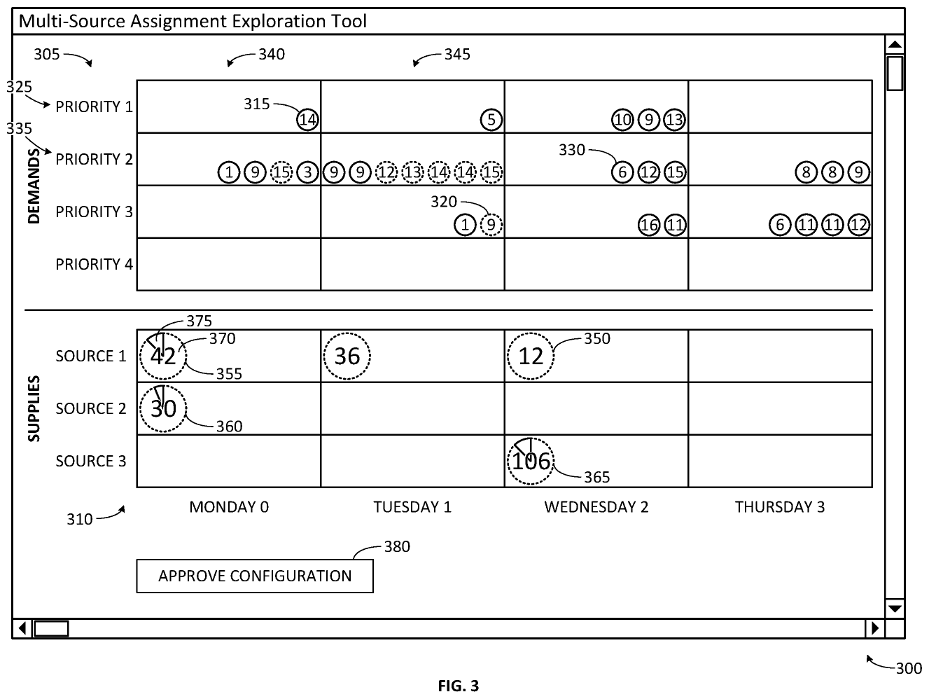

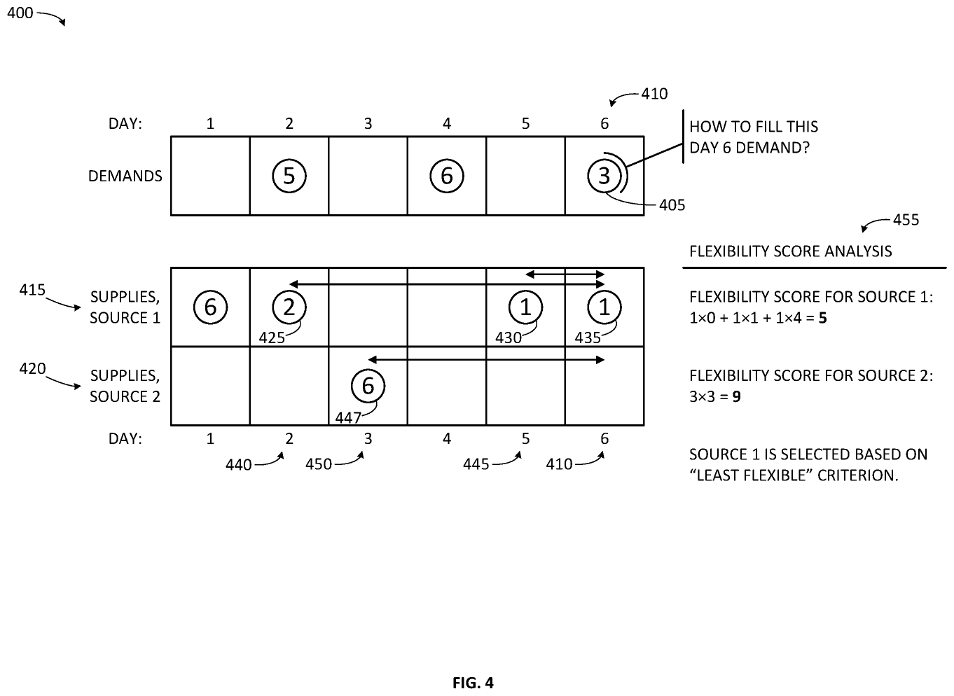

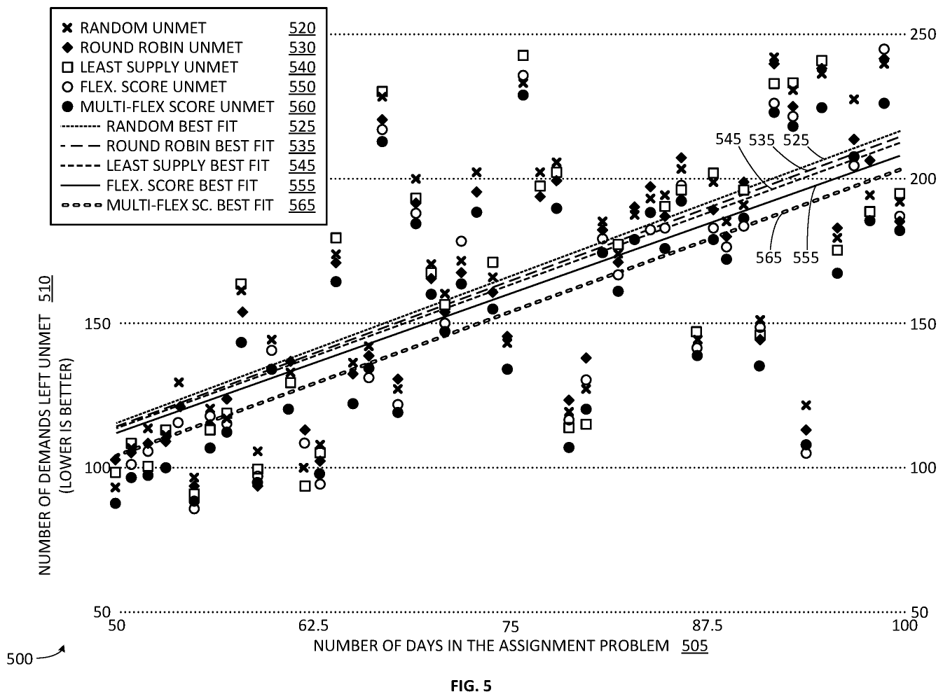

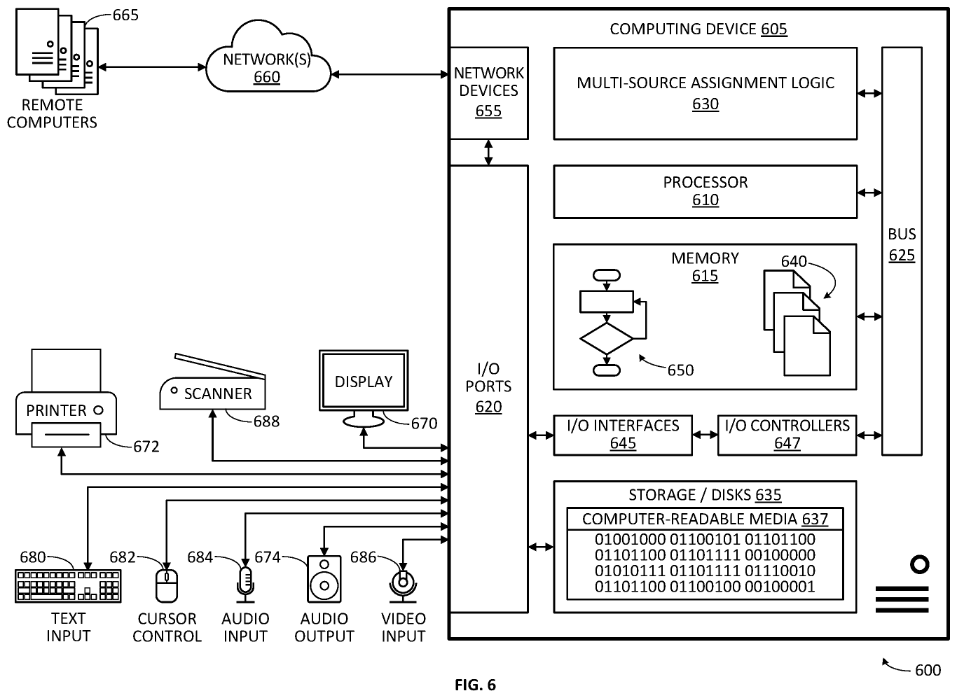

Further details regarding multi-source assignment system 100 are presented herein. In one embodiment, the operation of multi-source assignment system 100 will be described with reference to an example multi-source assignment method 200 shown in and described with reference to FIG. 2. In one embodiment, a multi-source assignment tool 300 as shown in and described with reference to FIG. 3 makes use of multi-source assignment system 100 and method 200 to perform interactive, real-time “what-if” explorations of assignment configurations. In one embodiment, further details regarding one source selection technique are shown in and described with reference to FIG. 4 Experimental validation of improved accuracy levels of various embodiments of multi-source assignment system 100 are as shown in and described with reference to FIG. 5. Cloud and other computing system embodiments of multi-source assignment system 100 are shown in and described with reference to FIG. 6.

### —Example Method for Multi-Source Assignment—

FIG. 2 illustrates one embodiment of a multi-source assignment method 200 associated with assigning supply to demand from multiple supply sources. At a high level, in one embodiment, multi-source assignment method 200 identifies supplies from one source out of multiple sources from which to fill a demand for a resource.

In one embodiment, as an overview, multi-source assignment method 200 sorts a set of demands by size of demand. Multi-source assignment method 200 then generates a set of assignments between demands belonging to the set of demands and supplies. The supplies are held at multiple sources. In one embodiment, the set of assignments is generated by performing a set of operations for each demand to produce an individual assignment for each demand. The operations are repeated in a loop for each individual demand in ascending order of the size of the demand to populate the full set of assignments. One operation in the loop is identifying from among the multiple sources a set of sources having sufficient supply to fill the demand. A subsequent operation in the loop is choosing one source from the set of sources from which to fill the demand. A further operation in the loop is assigning the demand to be filled from one or more supplies of the one source to form an assignment for the demand in the set of assignments. Once the set of assignments is thus generated, multi-source assignment method 200 allocates the supplies to the demands belonging to the set of demands in accordance with the set of assignments.

In one embodiment, multi-source assignment method 200 initiates at start block 205 in response to a processor of a computer configured (for example with logic 630) to execute functions of multi-source assignment system 100 determining that the method should commence. In one embodiment, multi-source assignment method 200 commences in response to the processor determining one or more of: (i) that an assignment exploration tool has initialized or changed a configuration or parameter of supplies and demands; (ii) that supplies are to be automatically assigned to demands; (iii) that a user (or administrator) of the operations management system has initiated method 200; (iv) that method 200 is scheduled to be initiated at defined times or time intervals; (v) that a user of a GUI associated with method 200 has performed an action in response to which the method 200 should be performed; or (vi) that method 200 should commence in response to occurrence of some other condition. Multi-source assignment method 200 continues to process block 210.

At process block 210, the processor sorts a set of demands by size of demand. In one embodiment, the processor parses demands in the set to identify the size of a demand, or quantity of units to entirely fill the demand. The processor then arranges the set of demands in order based on the sizes of the demands. In one embodiment, the sort algorithm may be any general sorting algorithm suited to operation on large lists, such as merge sort, heapsort, or other sort. In one embodiment, the set of demands is arranged in ascending order based on size of demand, such that the smallest demands appear first and the largest demands appear last following completion of the sorting. This produces a non-prioritized sorted set of demands, or a sorted set of demands with only one priority level. In one embodiment, the sorted set of demands may be stored as a data structure containing the demands and an indication of the sort order.

In one embodiment, a demand is further associated with a priority level in relation to other demands. In one embodiment, the processor sorts the demands having a priority level in common by size of demand. In one embodiment, the demands are sorted by size for each priority level. In one embodiment, the group of sorted demands for each priority level are appended or concatenated together in order of priority to produce a prioritized sorted set of demands. In one embodiment, in the prioritized sorted set of demands the sorted set of highest priority demands (priority level 1 demands) appears followed by the sorted set of the next highest priority demands (priority level 2 demands), and so on through the lowest priority demands. In this manner, the prioritized sorted set places a sorted group of demands having a superior (higher) priority level before a sorted group demands having an inferior (lower) priority level.

Process block 210 then completes, and multi-source assignment method 200 continues at process block 215. In one embodiment, at the completion of process block 210, the demands are placed in an order for evaluation to assign supply. Under the goal of fill rate optimization, smaller demands should be assigned supply before larger demands. This conserves available supply and distributes it over more demands. By sorting the demands in the set by size, smaller demands are considered for assignment of supply before larger demands. By sorting the demands in the set by size within a priority level, larger demands with higher priority are considered for assignment of supply before smaller demands with lower priority.

At process block 215, the processor generates a set of assignments between demands belonging to the set of demands and supplies at multiple sources. In one embodiment, for those demands that are to be fulfilled, the processor may generate a data structure indicating the supply, the quantity of units supplied, and a demand to which the units are assigned. As discussed herein, supplies may be held at multiple sources, such as discrete warehouse locations. In one embodiment, demands are constrained to receive units from a single source, although the units may come from multiple supplies at the source.

In one embodiment, the generating the set of assignments between demands and supplies is performed by generating individual assignments for each of the demands in ascending order of the size of demand. In one embodiment, the generation of the individual assignments is performed as a loop 217. In loop 217, an individual assignment is created and added to the set of assignments in each iteration. In one embodiment, loop 217 iterates through the sorted set of demands from the initial, least sized demand to the final, greatest sized demand in the set. In one embodiment, the demands may be indexed by their position d in the sorted order. In one embodiment, the set of demands is of size D, including D demands.

In one embodiment, the position index d is initiated to the position of the initial demand, for example, d=1. Processing enters loop 217 at decision block 220. At decision block 220, the processor compares the position index d to the size D of the set of demands to determine whether the position index d remains within (that is, is less than or equal to) the number of demands D in the set. If so (block 220: YES), processing continues to process block 225. Loop 217 is shown in process block 215 as a “while” loop, other loop forms such as a “do-while” loop may also be employed.

At process block 225, the processor identifies a set of sources having sufficient supply to fill the demand from among the multiple sources. In one embodiment, for each source, the processor finds the total quantity of un-assigned units available from the supplies at the source. To identify the set of sources having sufficient supply to fill the demand, the processor compares the size of the demand to the total quantity of un-assigned units for each source in turn. Where the total quantity of un-assigned units for a source is greater than or equal to the size of the demand, the source is added to the set of sources having sufficient supply to fill the demand. Where the total quantity of un-assigned units for a source is less than the size of the demand, the source is excluded from the set of sources having sufficient supply to fill the demand. In one embodiment, the set of sources may be recorded as a data structure indicating the demand and the sources in the set.

Process block 225 then completes, and loop 217 continues at process block 230. At the completion of process block 225, a set of sources that are capable of filling one demand has been identified. Sources that cannot fill the demand are removed from consideration. One of the identified set of sources may subsequently be assigned to fill the demand.

In one embodiment, where no source has sufficient supply to fill the demand, the demand cannot be filled, and will be marked or tagged as unfilled, for example in the set of assignments. Thus, in one embodiment, where no source has sufficient supply to fill the demand, the loop 217 bypasses further processing in process block 230 and 235 and proceeds immediately to process block 240 to skip on to the next demand.

At process block 230, the processor chooses one source from the set of sources from which to fill the demand. As discussed in further herein below, the method for choosing the one source may vary. In one embodiment, the one source from which to fulfill the demand may be selected by one of: a random selection algorithm, a “Round Robin” algorithm, a “Least Supply” algorithm, a “Flexibility Score” algorithm, and a “Multi-Flexibility Score” algorithm, as discussed below. In one embodiment, the choice of source may also identify the specific supplies of the source that will supply the units to fill the demand. Process block 230 then completes, and loop 217 continues at process block 235. At the completion of process block 230, one source has been selected to provide units from its supplies to fill the demand.

At process block 235, the processor assigns the demand to be filled from one or more supplies of the one source to form an assignment for the demand in the set of assignments. In one embodiment, the assigning generates a data structure that records a quantity of units assigned to the demand from one or more supplies at the source. In one embodiment, this record of the quantity of units assigned to the demand from the supplies is added to the set of assignments. In one embodiment, the assigning updates the record of assigned and un-assigned units of the supplies. In one embodiment, following the updates the number of un-assigned units of the supplies will be accurate for subsequent analysis as to whether the source has a total quantity of un-assigned units to fill a subsequent demand in the set of demands.

Process block 235 then completes, and loop 217 continues at process block 240. At the completion of process block 235, an assignment that satisfies one demand is added into the set of assignments, and the units assigned to the demand are deducted from the supplies at the source. The loop 217 proceeds to evaluate the next demand in the sorted set of demands.

At process block 240, the position index d is incremented by 1. Processing then returns to the head of loop 217 at decision block 220 to determine whether there remain further demands to process. Loop 217 repeats until no further demands remain in the sorted set of demands. Process block 215 then completes, and multi-source assignment method 200 continues at process block 245. At the completion of process block 215, a set of assignments has been generated that indicates, for those demands that can be filled, the supplies from which the demands are filled. This set of assignments may be used to allocate the supplies to the demands.

At process block 245, the processor allocates the supplies to the demands belonging to the set of demands in accordance with the set of assignments. In one embodiment, the allocation of the supplies to the demands includes automatically generating and transmitting an allocation instruction to cause the demands to be fulfilled from the supplies as described by the set of assignments.

In one embodiment, the allocation of the supplies to the demands includes automatically updating a display of filled and unfilled demands to show a configuration described by the set of assignments (for example as shown and described herein with reference to multi-source assignment exploration tool 300). In one embodiment, performance of method 200 may be automatically initiated or repeated in response to interactive manipulation of the display of filled and unfilled demands. In one embodiment, allocations of the supplies may be repeatedly updated in the display by interactive re-configuration of displayed demands and supplies until a user-selectable element to accept or approve the configuration is selected. In one embodiment, the system may accept a user selection of the element to approve the configuration, indicating that the user is satisfied with the displayed configuration. In one embodiment, in response to the selection of the element to approve the configuration, the system automatically generates and transmits the allocation instruction.

Process block 245 then completes, and multi-source assignment method 200 continues at END block 250, where method 200 completes. At the completion of method 250, supplies are assigned to meet demands in a short-supply situation where the supplies may come from multiple sources. This is a highly challenging and resource-intensive compute task that is greatly simplified by performance of method 200, reducing both compute time and memory requirements.

In one embodiment, choosing the one source from the set of sources as discussed above with reference to process block 230 may include steps for choosing based on flexibility scores (flexibility score is also referred to herein as a “center of mass”) for sources. In one embodiment, the flexibility score quantifies or characterizes how early the overall supplies at a source are made available. In one embodiment, the processor determines flexibility scores for sources in the set of sources. In one embodiment, the flexibility score is determined based on the size of the demand, a time of fulfillment for the demand, and a time of availability of supply for the source. As used herein, “time of fulfillment” for a demand is a date and/or time at which the demand is to be filled. As used herein, “time of availability” for a supply is a date and/or time at which the supply becomes available at the source. In one embodiment, based on the flexibility scores, the processor identifies a least-flexible source among the set of sources that has a flexibility score indicating supply closest to the time of fulfillment for the demand. In one embodiment, the processor selects the least-flexible source to be the one source from which to fill the demand.

In one embodiment, the flexibility score F of a source is the sum, over all supplies S in the source, of the product of the number of supply units u taken from the supply and the distance in time t from the supply date (time of availability) to the demand date (time of fulfillment), as shown more formally in Eq. 1 below:

F=Σₛ₌₁^{S}(uₛ×tₛ) Eq. 1

Supplies in a source that do not contribute units to fulfill the demand are disregarded in the flexibility score because the supplies are zeroed-out by their value of u. Supplies in a source that have a supply date occurring on the demand date are disregarded in the flexibility score because the supplies are zeroed-out by their value of t (or are assigned a value tₛ=0). When comparing flexibility scores generated in accordance with Eq. 1, the lower score indicates a less-flexible source. Further detail regarding the flexibility score or center of mass source selection method for choosing one source from the set of sources is shown and described below with reference to FIG. 4.

In one embodiment, in order to select the least flexible source, the processor selects the least-flexible source at random from among multiple sources having equal flexibility scores. Thus, in one embodiment, random source selection is the method used to break a tie between sources for the position of least flexibility score. Further detail on the random source selection method and tie-breaking is provided below in the section entitled “Example Multi-Source Assignment Algorithms.”

In one embodiment, choosing the one source from the set of sources as discussed above with reference to process block 230 may include steps for multiple passes or runs through choosing based on the flexibility scores for sources. This may be referred to herein as multi-center of mass or multi-flexibility score source selection. In one embodiment, the multiple runs leverage the fact that ties may occur in the flexibility scores. In one embodiment, because choosing a source may remove the source from consideration for filling a subsequent demand in the list of demands, the system operates to create alternative assignment sets by varying the source selected when a tie occurs for least flexible source. In one embodiment, the generation of the set of assignments is repeated through multiple runs to create multiple sets of assignments until a condition is satisfied. In one embodiment, during a run of the multiple runs, multiple least-flexible sources having equal flexibility scores are identified. In one embodiment, the least flexible source is included in the multiple least flexible sources. In one embodiment, during the run, one source is selected from among the multiple least-flexible sources at random to select the least-flexible source to be the one source. In one embodiment, once the condition is satisfied and no further runs are being performed, a one of the multiple sets of assignments is selected to be the set of assignments. In one embodiment the one of the multiple sets of assignments that was selected is the one that has a least number of unfilled demands. Further detail on multi-center of mass or multi-flexibility score source selection is provided below in the section entitled “Example Multi-Source Assignment Algorithms.”

In one embodiment, choosing the one source from the set of sources as discussed above with reference to process block 230 may include steps for choosing based on amount of supply that would be left to a source after an assignment. In one embodiment, the processor identifies a least-supply source among the set of sources that will be left with a least amount of total supply upon fulfillment of the demand. In one embodiment, the processor selects the least-supply source to be the one source from which to fill the demand. This may be referred to herein as least supply source selection, and is discussed in further detail below in the section entitled “Example Multi-Source Assignment Algorithms.”

In one embodiment, choosing the one source from the set of sources as discussed above with reference to process block 230 may include steps for choosing based on cycling through the multiple sources. In one embodiment, the processor identifies a next source in a cycle through the multiple sources. In one embodiment, the next source is also in the set of sources from which the demand can be filled. In one embodiment, the processor selects the next source to be the one source from which to fill the demand. This may be referred to herein as round robin source selection, and is discussed in further detail below in the section entitled “Example Multi-Source Assignment Algorithms.”

In one embodiment, choosing the one source from the set of sources as discussed above with reference to process block 230 may include steps for randomly selecting a source from which the demand can be filled. In one embodiment, the processor identifies a random source among the set of sources. In one embodiment, the processor selects the random source to be the one source from which to fill the demand. This may be referred to herein as random source selection, and is discussed in further detail below in the section entitled “Example Multi-Source Assignment Algorithms.”

Thus, in one embodiment, choosing the one source from the set of sources of process block 230 may be performed using one of several distinct processes. In one embodiment, the processor causes the computing system to select as the one source from which to fill the demand one of: (i) a least-flexible source in terms of earliness of supply availability; (ii) a source that will be left with a least amount total supply upon fulfillment of the demand; (iii) a source that is next in a cycle through the multiple sources; or (iv) a random source; for example as discussed above.

In one embodiment, the processor excludes from the set of demands those demands that are constrained to be unmet. In one embodiment, the demands that are constrained to be unmet are excluded or removed from the set of demands before the set of demands are sorted. Excluding demands constrained to be unmet is a preparatory step that precedes the actions described for process block 210. Excluding demands constrained to be unmet is discussed in further detail below in the section entitled “Example Multi-Source Assignment Algorithms.”

In one embodiment, the processor fills all demands in the set of demands that are constrained to be met. In one embodiment, the processor extracts the demands that are constrained to be met from the set of demands. The processor then places the demands that are constrained to be met, in ascending order of demand quantity, at the beginning of the set of demands. The demands that are constrained to be met are followed by the remaining, unconstrained demands, in ascending order of demand quantity. Filling demands constrained to be met is discussed in further detail below in the section entitled “Example Multi-Source Assignment Algorithms.”

In one embodiment, a user interface is provided for exploration of the effects of modifying parameters or configurations of the demands or supplies. In one embodiment, the processor presents a user interface including an option to enter an input that adds, removes, or changes parameters of the demands or supplies. In one embodiment, the processor accepts the input. In one embodiment, the generation of the set of assignments discussed above with reference to process block 215 is performed in real-time in response to accepting the input. In one embodiment, the processor displays information showing the fulfillment status of the demands based on the assignments between demands and supplies. In one embodiment, the processor presents a user-selectable option to fill the demands belonging to the set in accordance with the assignments between demands and supplies. In one embodiment, the transmitting the instruction is performed in response to selection of the user-selectable option. One example user interface is the multi-source exploration tool 300 shown and described herein with reference to FIG. 3.

In one embodiment, identifying from among multiple sources a set of sources from which a demand can be filled as discussed above with reference to process block 225 may include steps for identifying the sources based on times (including dates) associated with demands or supplies. In one embodiment, in the course of identifying the sources at process block 225, the processor compares a time of fulfillment of the demand and a time of availability of supply for the source, for example as shown and described herein.

As discussed above with reference to process block 210, the demands may have various priorities in relation to other demands. In one embodiment, the processor subdivides the set of demands by level or value of priority. In one embodiment, the generation of the set of assignments is performed for demands having a superior priority level before the generation of the set of assignments is performed for demands having an inferior priority level. Prioritization of demands is also discussed in further detail below in the section entitled “Example Multi-Source Assignment Algorithms.”

### —Discussion of Multi-Source Assignment—

Examples are described herein in the context of selecting warehouse sources of supply of goods for fulfillment of demands for the goods. In one embodiment, the systems, methods, and other embodiments described herein may assign supplies of other resources from other types of sources. For example, the multi-source assignment systems and methods shown and described herein may be used to choose sources in fields as diverse as utility distribution, vehicle dispatch, and computing bandwidth allocation. In one embodiment, the multi-source assignment systems and methods shown and described herein find application wherever a resource is in short supply and fill rate is to be optimized.

In one embodiment, a goal of an order fulfilment system may be to fill as many orders as possible using existing supply. This goal may be termed “fill rate optimization.” In one embodiment, the systems, methods, and other embodiments described herein for multi-source assignment provide for filling as many orders as possible using existing supply. Where supply quantity is plentiful and meets or exceeds demand quantity, this assignment task may be simple. Where supply quantity is short and is less than demand quantity, the task of filling as many orders as possible becomes computationally complex. The computationally complex task of filling as many orders as possible when supply is short demands allocation of significant computing resources to complete. Filling as many orders as possible when supply is short is made even more computationally complex and demanding of resources when multiple supply sources are available.

In one embodiment, an order for units of a resource is a “demand,” as defined above. In one embodiment, a demand is characterized by a size (such as a number of units), a priority (for example, ranging from 1 through 4), and a date and/or time of fulfillment (for example, the date upon which the order is to ship). In one embodiment, the foregoing features completely characterize a demand. In one embodiment, destination of the order is assumed to be irrelevant. Thus, in one embodiment, demands have no physical location recorded. In one embodiment, shipping costs are assumed to be identical, or to be minor, or assumed to somehow average out, or are otherwise not relevant.

In one embodiment, a stock of units of a resource is a “supply,” as defined above. In one embodiment, a supply is characterized by a size (number of units), a location (referred to herein as a “source” or “warehouse”), and a date and/or time of availability (for example, the date upon which the supply becomes available for distribution at its source). In one embodiment, the foregoing features completely characterize a supply. Note that there may be multiple supplies at a source. As used herein, the term “source” does not refer to a supply or stock of units itself, but instead indicates a discrete location, point, or thing (such as a warehouse) from which a stock of units or supply is made available to fill demands.

In one embodiment, any unit of supply can be applied to fill or partially fill any demand of the same date or any future date, but not on a past date. For example, a supply arriving on a date cannot be used to fill demands that ship before the arrival date of the supply. Or, for example, a supply arriving on a date may be used to fill demands on the same date, or on subsequent dates. In one embodiment, at the source (for example, in the warehouse), supply does not expire or “go bad” such that it can no longer be used to fill present and future demands. Thus, unused supply may be gradually used to fill demands over time, until the supply is completely depleted.

In one embodiment, fill rate optimization is constrained to cause each demand to be either completely satisfied, or left empty. Partial orders are not included in the fill rate optimization solution. Thus, at times, portions of unused supply may remain despite the presence of unfilled demands. Optionally, the system may accept user input to manually create a partial order fulfillment, adjust priority of demands relative to one another, initiate moving supply early, or manually adjust the assignment of supply.

In one embodiment, demands may be prioritized in relation to other demands, as discussed above. In one embodiment, assignment to demands of higher priority are resolved first before demands of lower priority are considered.

In one embodiment, demands are constrained to be filled from a single source. For example, a demand is filled using one or more supplies from a single warehouse. Thus, for example, for any given demand, all supply assigned to the demand comes from the same source.

In one embodiment, the multi-source assignment system is configured to enable users to perform real-time (or near-real-time), interactive, “what-if” explorations to test the impact of hypothetical supply and demand configurations. In one embodiment, the “what-if” exploration may involve adding, removing, or changing the parameters of existing supplies and demands, and/or constraining a demand to be met or left unmet. In one embodiment, the system will automatically execute the assignment problem in response to adjustment to the parameters or constraints of existing supplies and demands. In one embodiment, what-if explorations of assignment solutions may be performed for situations involving filling thousands of demands (for example, a calendar quarter's worth of demands or possibly even a year's worth), from supplies stored at many sources (for example, a dozen or more warehouses). Thus, in one embodiment, the multi-source assignment system produces a multi-source assignment solution that assigns one or more supplies from a source location to fill a demand. In one embodiment, the system may assign supplies to demands automatically in accordance with a multi-source assignment solution.

The multi-source supply assignment problem discussed above can be stated as a constrained linear programming problem, and so can be optimally solved using the Simplex algorithm. But, Simplex performance requirements scale exponentially or super-exponentially (that is, growing even faster than exponentially) with the complexity of the problem. Experimental implementation of a Simplex solution reveals that it can only solve small problems before taking an infeasibly long time to complete and potentially overwhelming available compute resources such as memory and processor time. For example, the Simplex solution often spends well over an hour to solve a problem in which a few tens of demands are scattered over a modest number of dates (a dozen or so) with supply from a few warehouses, as discussed below in further detail in the “Selected Advantages” section. Thus, use of a Simplex solution to perform interactive, real-time “what-if” explorations is impracticable. Further, finding assignments at a scale involving thousands of demands from supplies stored at multiple sources is impossible for a computing device, as the hardware will be overwhelmed by resource requirements for execution. Even if hardware limitations do not prevent completion of a solution using a Simplex or other standard solver, the time to complete the solution using the standard solver is impractically long, completing in a matter of hours, days, or more. Such delays can appear to a user as a “frozen” or otherwise failed process, and render Simplex and other standard solvers unacceptable for solving multi-source supply assignment problems for automatic assignment or for interactive, real-time exploration. And, even for small multi-source supply assignment problems, the solution time renders Simplex implementations unacceptable for interactive, real-time exploration. Thus, for multi-source supply assignment, alternatives to the Simplex algorithm are needed. The Simplex implementation provides only a performance benchmark against which the improved solutions herein may be compared.

### —Example GUI for Multi-Source Assignment Exploration—

FIG. 3 illustrates one embodiment of multi-source assignment exploration tool 300 associated with assigning supply to demand from multiple supply sources. In one embodiment, at a high level, multi-source assignment exploration tool 300 is a user interface representing a solution to an example assignment problem, with supplies (represented at the bottom of the user interface) assigned to demands (represented at the top of the user interface). In one embodiment, multi-source exploration tool 300 is a graphical user interface (GUI) for interactive exploration and viewing of configurations of assignments between demands and supplies at multiple sources. In one embodiment, multi-source assignment exploration tool 300 shows example results or solution of assignment for a small problem of four days, with time running left to right. In one embodiment, multi-source exploration tool 300 includes a demand display region 305. In one embodiment, multi-source exploration tool 300 includes a supply display region 310.

In one embodiment, demand display region 305 includes one or more individual demands displayed as demand icons. In one embodiment, a demand icon shows a demand quantity for the demand that the demand icon represents. For example, demand icon 315 represents a demand for 14 units. In one embodiment, a demand icon provides a visual indication of a status of a demand in a particular assignment solution. In one embodiment, the statuses may include that the demand is met, unmet, constrained to be met, or constrained to be unmet. In one embodiment, these statuses may be represented by different colors of demand icons in multi-source exploration tool 300. In one embodiment, met demands may be represented by a green icon (represented in FIG. 3 as a demand icon with a solid outline), such as demand icon 315. In one embodiment, unmet demands may be represented by a yellow icon (represented in FIG. 3 as a demand icon with a dotted outline), such as demand icon 320. Other colors or graphical features on the demand icon may be used to indicate that the demand represented by the icon is constrained to be met or unmet.

In one embodiment where demands have an associated priority, demand display region 305 displays demand icons in rows or ranks associated with the priority of the demand. For example, icons for demands with a priority level or value of 1 (such as demand icon 315) are displayed in “Priority 1” row 325, icons for demands with a priority value of 2 (such as demand icon 330) are displayed in “Priority 2” row 335, and so on. In one embodiment where demands do not have an associated priority (or where multi-source assignment exploration tool 300 has been configured to disregard demand priority), demand display region 305 displays demand icons in a single rank or row.

In one embodiment, demand display region 305 displays demand icons in columns associated with the day that the demand is to be filled (for example, shipped). For example, icons for demands to be filled on Monday (day 0 or the initial day of the example assignment problem) are shown in “Monday 0” column 340, icons for demands to be filled on Tuesday (day 1 or the first day following the initial day of the example assignment problem) are shown in “Tuesday 1” column 345, and so on.

In one embodiment, a first color (such as green) indicates the presence of units and a second color (such as yellow) indicates the absence of units in solutions displayed by the multi-source assignment exploration tool 300. In the supply and demand icons shown, the first color (such as green) is indicated by a solid outline, and the second color (such as yellow) is indicated by a dashed or dotted outline. In one embodiment, a solid green demand icon (such as demand icon 315) represents a demand that is completely filled, having units assigned to it from one or more supplies. In one embodiment, a solid yellow demand icon (such as demand icon 320) represents a demand that is entirely unfilled, having no units assigned to it.

In one embodiment, supply display region 310 includes one or more individual supplies displayed as supply icons. In one embodiment, a supply icon shows a supply quantity for the supply that the supply icon represents. For example, supply icon 350 represents a supply of 12 units, and supply icon 355 represents a supply of 42 units. In one embodiment, a supply icon provides a visual indication of a status of a supply in a particular assignment solution. In one embodiment, the statuses may indicate disposition of the units of a supply, whether the units of the supply are fully assigned to fill demands, partially assigned and partially unassigned, or entirely unassigned.

In one embodiment, these statuses may be represented by distinct colors in the supply icons in multi-source exploration tool 300. In one embodiment, an all-yellow (all-second color) supply icon (such as supply icon 350) represents a supply that has had all of its units assigned to one or more demands in the example solution displayed in multi-source assignment exploration tool 300. In one embodiment, the all-yellow color of a supply icon indicates that all of its units are assigned, and no further units are available from the supply for assignment. In one embodiment, an all-green (all-first color) supply icon (not shown in the example solution) represents a supply that has all of its units available for assignment.

Note that in the example solution, some small bits of supply remain. This is due to the constraint, in one embodiment, on fill rate optimization that all demands be completely filled, or not filled at all. If it is not possible to completely fill a demand, some supply may be left unused or unassigned. In one embodiment, remaining amounts of unassigned supply are represented in supply icons in a pie chart or other chart or graphical form. For example, supply icons 355, 360, and 365 are divided into portions representing both assigned supply and unassigned supply. Supply that is assigned is represented by a yellow portion of the supply icon, such as portion 370 of supply icon 355. Supply that remains unassigned is represented by a green portion of the supply icon, such as portion 375 of supply icon 355.

In one embodiment, a supply is associated with a particular source or location from which the supply may be used to fill demands. As discussed herein, in one embodiment, all units of supply used to fill one demand are constrained to be from a single source. Therefore, in one embodiment, supply display region 310 displays supply icons in rows associated with the sources of the supplies. For example, in the example solution presented in multi-source assignment exploration tool 300, the individual supplies are each placed within one of three rows representing three discrete sources or locations.

In one embodiment, multi-source exploration tool 300 may accept user input to move supply and demand icons, or mark demands to be constrained to be met or to be unmet. In one embodiment, the user can drag and drop supply and demand icons, and mark demand icons with indications of the constraints. In one embodiment, the multi-source exploration tool 300 parses these inputs and automatically implements them in a new or updated solution to the assignment problem.

In one embodiment, the supply assignments update interactively in response to the inputs. For example, the icons may update automatically in response to a new configuration of assignment of supplies in multiple sources to demands that results from the inputs. In one embodiment, the icons update automatically in response to the inputs in order to present the new or updated solution. In one embodiment, the pie chart ratios of assigned and remaining quantities of supply update automatically in response to the inputs in order to present the new or updated solution. This interactivity supports “what-if” exploration of the assignment problem. The interactivity is made possible by the systems and methods described herein, and would not otherwise be possible with existing algorithms.

In one embodiment, hovering a cursor over (or performing some other interaction with) a demand or supply causes multi-source exploration tool 300 to present a popup region including information describing the demand or supply. In one embodiment, in response to hovering a cursor over a demand, a popup region providing details of the assignment for the demand is automatically presented. In one embodiment, in response to hovering the cursor over the demand, multi-source exploration tool 300 also highlights the source supplies for the demand. In one embodiment, the popup region may include one or more of demand quantity, demand priority level, demand fulfillment date, a breakdown of assigned supplies indicating a count of units of supply assigned from one or more supplies in a source and/or the assignment status (assigned/unassigned) of other units from those supplies, or other information about the demand.

In one embodiment, in response to hovering a cursor over a supply, a popup region including information providing details of the assignments from the supply is automatically presented. In one embodiment, in response to hovering the cursor over the supply, multi-source exploration tool 300 also highlights the demands that are filled from the supply. In one embodiment, the popup region may include one or more of supply quantity, supply arrival date, a breakdown of the demands indicating a count of units of supply assigned to one or more demands, or other information about the supply.

In one embodiment, multi-source exploration tool 300 includes an “approve configuration” button 380. In one embodiment, selecting the “approve configuration” button 380 acts to select the currently displayed configuration of assignments for implementation by an order fulfillment system. “Approve configuration” button 380 is thus a user-selectable option to fill the demands in accordance with the assignments between demands and supplies. In one embodiment, in response to selection of button 380, multi-source assignment system 100 will automatically generate an allocation instruction to fill demands in accordance with the set of assignments displayed. The multi-source assignment system 100 will then automatically transmit the allocation instruction to an order fulfillment system. In one embodiment, the order fulfillment system parses the allocation instruction and executes it to cause the demands to be automatically filled in accordance with the set of assignments. In one embodiment, the allocation instruction initiates and or controls activities performed in order to fulfill the demands. For example, the allocation instruction may cause: (i) printing, display, or transmission (for example by email, fax, text, Electronic Data Interchange or other protocol) of pick and/or pack instructions to the location of the source in order to effect the fulfillment of the demand using the assigned supplies; or (ii) one or more robots or other automated machines at the location of the source to retrieve the identified supply quantities of units, pack the retrieved units, and ship the packed units to fulfill the demand using the assigned supplies.

### —Example Multi-Source Assignment Algorithms—

Simplex algorithm-based implementation exhibits unacceptably slow performance to be used for interactive exploration of assignment solutions in real- or quasi-real-time. (As used herein, quasi-real-time refers to a substantially real-time operation with an acceptable human-scale delay between input and results, which generally range from a few seconds to a few minutes.) But, the multi-source assignment system may implement a variety of other supply source selection algorithms that have sufficiently swift performance for operation in or near real time.

In one embodiment, multi-source assignment systems and method selects supply sources from which to assign supplies to demands using one of a random selection algorithm, a “Round Robin” algorithm, a “Least Supply” algorithm, a “Center of Mass” (or “Flexibility Score”) algorithm, and a “Multi-Center of Mass” (or “Multi-Flexibility Score”) algorithm (referred to collectively herein for convenience as “the five algorithms”). Each of the five algorithms make the method suitable for quickly repeated performance to allow a user to interactively explore the effect of rearranging or reconfiguring supplies and/or demands (investigating “what-if” scenarios). Further detail describing the performance of the five algorithms is shown and described below with reference to FIG. 5.

In one embodiment, the five algorithms begin with preparatory steps. First, demands marked as constrained to be left unmet are removed from consideration. Because they are constrained to be unmet, they need not be included in the multi-source assignment analysis. The demands may be removed from consideration by filtering out the demands based on a flag, tag or data structure indicating that the demand is constrained to be unmet. The demands marked as constrained to be unmet may be retained for later presentation as unmet demands along with the results of the multi-source assignment analysis.

Then the remaining demands are sorted from small to large with the smallest demand considered first. In one embodiment, where the demands are prioritized, the demands for one level of priority are sorted from small to large, and the demands of a second level of priority are also sorted from small to large, and so on sorting demands from small to large through the priority levels. Thus, where the demands are prioritized, the demands are sorted from small to large within a priority level. Where there are not multiple sources (warehouses), this sorting step can lead to a true optimal solution. Sorting demands from small to large (within priority level) and then considering the demands in sorted order is a provably optimal approach to the single-source version of the problem. In one embodiment, sorting demands from small to large (within priority level) therefore provides a common-sense basis for solving a multi-source assignment problem: spending limited supply on small demands will tend to give a higher fill count than choosing to try to fill larger demands.

In one embodiment, each of the five algorithms attempts to fill all demands marked as constrained to be met, using its algorithm-specific demand-filling strategy. If this is not possible, an error is thrown to indicate that all demands constrained to be met cannot be met by the available supply. In one embodiment, the demands are parsed to identify a flag, tag or data structure indicating that the demand is constrained to be met. The demands that are constrained to be met are filled before filling other demands that are not constrained to be met. In one embodiment, the demands marked as constrained to be met as if they have a most superior priority over other demands that are not marked as constrained to be met

In one embodiment, as the algorithm moves down the sorted list of demands to consider the next demand d, it first collects the warehouses that can be used to fill d into a set S of sources (e.g., warehouses) having sufficient supply to fill the demand d. In one embodiment, here is where the five algorithms differ: Each of the five algorithms employs a different strategy for choosing which of the possibly many sources in set S will be used use to actually fill demand d. In one embodiment, the algorithm uses one of a random method, a round robin method, a least supply method, a center of mass or flexibility score method, or a multi-center of mass or multi-flexibility score method.

Random source selection method: In one embodiment, the random method selects a random source (e.g., warehouse) from set S of sources to be the source used for the assignment to fill demand d.

Round Robin source selection method: In one embodiment, the Round Robin method will move through the list of all sources (e.g., warehouses) in a cycle. Where a source in the cycle is not in set S, it is skipped and the next source in the cycle is considered, and so on until a source in set S is found. The first source in set S encountered in the cycle is thus selected to be the source used for the assignment to fill demand d.

Least Supply source selection method: In one embodiment, the Least Supply method evaluates the sources in set S to determine the source that would be left with the least total supply after the assignment. The source that would be left with the least total supply after the assignment is thus selected to be the source used for the assignment to fill demand d. The intuition in this case is that this manner of operation will leave much of the remaining supply concentrated into a few sources (e.g., warehouses), making subsequent assignments easier or faster.

Center of Mass (Flexibility Score) source selection method: The “Center of Mass” (or “Flexibility Score”) approach is based on the notion that the most flexible supply units are those that are earlier along the timeline. For example, a supply on day 1 can fill any demand, whereas a supply of the same size on the last day can fill only demands on the last day.

Therefore, in one embodiment, when selecting a source (e.g., warehouse) to fill demand d, the source that is selected should be the one having supplies that are the farthest forward in time, with supplies arriving on the day of demand d if possible. This leaves remaining supply units placed earlier on the timeline, thereby conserving the more flexible supply units for subsequent assignments.

FIG. 4 illustrates an example situation 400 in which a flexibility score analysis is performed to assign supply to demand from multiple supply sources. Choosing between sources this way can be complicated though, as in general some supply close in time to demand d may be available, but without all the units d needs. As an example, consider the example situation 400 shown in FIG. 4, in which a 3-unit demand 405 with a time of fulfillment on day 6 410 is to be filled. FIG. 4 illustrates one example of how to select a source using the center of mass or flexibility score approach. Two sources are shown, source 1 415 and source 2 420. Both source 1 415 and source 2 420 can fill 3-unit demand 405. Filling 3-unit demand 405 from source 1 415 would use supplies 425, 430, 435 having time of availability spread over three different days, day 2 440, day 5 445, and day 6 410. The second warehouse can fill 3-unit demand 405 completely using supply 447 from day 3 450.

An example flexibility score analysis 455 is shown in FIG. 4. Example flexibility score analysis 455 illustrates how to calculate the “center of mass” or flexibility score for the two sources, source 1 415 and source 2 420, each of which could fill the 3-unit demand 405 on at the time of fulfillment on day 6 410.

The center of mass notion is intended to capture in a single number or flexibility score a characterization of the timeline distribution of supplies that would be used by the warehouse to fill the given demand. To calculate the center of mass (F) of a set of supplies, multiply the number of supply units used from a supply by the distance in time (t) from the supply date (time of availability) to the demand date (time of fulfillment), and sum up all such products to generate a flexibility score. This calculation is discussed more formally above with reference to Eq. 1.

So, in the example flexibility score analysis 455, for source 1 415 there is 1 unit (of supply 435) at distance 0 from the time of fulfillment of demand 405, 1 unit (of supply 430) at distance 1, and 1 unit (of supply 425) at distance 4, creating a flexibility score (center of mass) of 5. In the example flexibility score analysis 455 for source 2 420, there is only one term, 3 units (of supply 447) times 3 day's distance for a flexibility score of 9. In the center of mass (flexibility score) algorithm, the source with the least flexibility score or center of mass is chosen to be the source from which to fill the demand. In example situation 400, the source chosen is source 1 415, because it has a flexibility score of 5, which is less than the flexibility score of 9 for source 2 420.

In one embodiment, if there are ties between sources for the position of least flexibility score, a secondary choice mechanism is used to choose from among the tied sources. In one embodiment, the random source selection method is used as the tie-breaker to select one of the sources with the least flexibility score. In one embodiment, the Round Robin source selection method is used to break the tie and select one of the sources with the least flexibility score. In one embodiment, the Least Supply source selection method is used to break the tie between the sources with least flexibility score and select one of them. In one embodiment, use of the Least Supply source selection method as a tie-breaker yields better results—filling more demands and/or having greater amounts of leftover supply—than the other selection methods. Therefore, in one embodiment, the Least Supply source selection method is may be preferred for picking a source from among the tied sources. In one embodiment, the choice of secondary method for tie-breaking does not make a significant difference in performance of the Flexibility Score source selection method.

Multi-Center of Mass (Multi-Flexibility Score) source selection method: Finally, the “Multi-Center of Mass” or “Multi-Flexibility Score” algorithm takes advantage of the fact that there are frequently ties among the sources (e.g., warehouses) for the position of having the least flexibility score (having the lowest-valued center of mass).

In a specific problem with multiple ties, one might construct all possible combinations of ways to thread through the various choices and then pick an overall winner, the one with most filled demands. Indeed, for small problems, there may be only a few ties, and the number of possible ways to do the entire assignment task is of manageable size so one could try them all. However, experimentation has revealed that for problems of even modest size, the number of ways to do the assignment amongst all possible ways to use the tied sources is combinatorially large, making a full enumeration almost always infeasible. Furthermore, it is not possible to count the number of possibilities without actually doing a full assignment for each possibility. This is because choosing source S to fill a demand may remove source S from contention when considering how to fill a subsequent demand. Thus, one could start the task of enumerating all possibilities doing a full assignment for each, but find there are just too many to support the goal of interactively speedy generation of assignment solutions. Using this scheme would slow down the common case.

So instead, many runs through all demands are performed, and a source is chosen randomly from among all ties each time a lowest center of mass tie is encountered. The run with the most filled demands is then selected as the solution to the multi-source assignment problem. In one embodiment, the many runs are as many runs as can be completed before a time out is reached. In one embodiment, the many runs are a pre-set or fixed number of runs. Thus, in one embodiment, alternative assignment sets are created by varying the source selected when a tie occurs for least flexible source. An alternative set that results in a least number of unmet demands can then be chosen for making assignments.

### —Performance of Multi-Source Assignment Algorithms—

The use of Simplex or other standard solvers is generally precluded for the interactive exploratory use due to long runtimes, and is restricted to small multi-source assignment problems due to long runtimes and the potential for a standard solver to exhaust memory resources. But, Simplex proves useful as a point of comparison or benchmark for the five algorithms for source selection because the Simplex solution is always a true optimum. In one embodiment, the five algorithms might not always reach the true optimum. Comparison of multi-source assignment solutions for the five algorithms with a Simplex solution gives an idea of how well each of the five algorithms perform. In one embodiment, the five algorithms usually find a true optimum for small assignment problems, although success in reaching a true optimum may drop off as problem size increases.

Experimental validations were performed for the five multi-source assignment algorithms. A large number of simulations were run for the five algorithms on benchmark compute hardware. The number of demands left unfilled was compared for the five algorithms. In one embodiment, the Multi-Center of Mass (Multi-Flexibility Score) method performs best, typically averaging about 10% fewer demands left unfilled (i.e., unmet) than the other multi-source assignment algorithms.

FIG. 5 illustrates a graph 500 of performance of the five multi-source assignment algorithms on sets of example multi-source assignment problems. A first axis 505 of graph 500 indicates number of days in a multi-source assignment problem. A second axis 510 of graph 500 indicates number of demands left unmet by in a solution by a multi-source assignment algorithm to a multi-source assignment problem. Lower is better in this graph of simulated run results using the 5 algorithms, plotting the number of demands left unfilled.

During the experimental validation, problems were generated randomly, but each for a given number of days, ranging from 50 to 100. The sets of example multi-source assignment problems thus range from a 50-day-sized to a 100-day-sized problem. In these example problems, runtimes for the various algorithms ranged from under one second to several seconds when executed on the benchmark compute hardware, with the exception of the Multi-Center of Mass (Multi-Flexibility Score) method. The Multi-Center of Mass (Multi-Flexibility score) method can run as long as the user wishes. The Multi-Center of Mass (Multi-Flexibility Score) method can easily implement a timeout, either through a simple check at the end of each of its many runs to determine if the timeout has elapsed, or with an interrupt when the timeout elapses. Or, the Multi-Center of Mass (Multi-Flexibility Score) method can be set to execute for a fixed number of runs. In the tests shown in graph 500, the Multi-Flexibility Score method was set to execute for a fixed number of runs, with the fixed number set to 25 runs. In the sets of example multi-source assignment problems, the largest runtime encountered for the 25-run Multi-Flexibility Score method was 42 seconds. The smallest runtime encountered was 7 seconds. The seven second runtime was for a 52-day problem. For smaller multi-source assignment problems, the runtime would be even less. All of these times seem roughly in line with the goal of supporting interactive, exploratory “what if” investigations by a user.

In graph 500, numbers of unmet demands in a solution by the random source selection method 520 given the number of days in an example multi-source assignment problem are marked with “x” points in graph 500. Graph 500 includes a random solution best fit line 525 for the unmet demands resulting from solutions by the random source selection method.

In graph 500, numbers of unmet demands in a solution by the round robin source selection method 530 given the number of days in an example multi-source assignment problem are marked with diamond-shaped points in graph 500. Graph 500 includes a round robin best fit line 535 for the unmet demands resulting from solutions by the round robin source selection method.

In graph 500, numbers of unmet demands in a solution by the least supply source selection method 540 given the number of days in an example multi-source assignment problem are marked with square points in graph 500. Graph 500 includes a least supply best fit line 545 for the unmet demands resulting from solutions by the least supply source selection method.

In graph 500, numbers of unmet demands in a solution by the flexibility score source selection method 550 given the number of days in an example multi-source assignment problem are marked with circle points in graph 500. Graph 500 includes a flexibility score best fit line 555 for the unmet demands resulting from solutions by the flexibility score source selection method.

In graph 500, numbers of unmet demands in a solution by the multi-flexibility score source selection method 560 given the number of days in an example multi-source assignment problem are marked with dot points in graph 500. Graph 500 includes a multi-flexibility score best fit line 565 for the unmet demands resulting from solutions by the multi-flexibility score source selection method.

The lower the number of unmet demands, the better the performance of the source selection method. Note that in experimental validation testing, the multi-flexibility score source selection method outperforms the other source selection methods by approximately 10%, the flexibility score source selection method outperforms the other source selection methods (except for the multi-flexibility score) by approximately 5%, the least supply source selection method outperforms the random and round-robin source selection methods, and the round-robin source selection method outperforms the random source selection method.

### —Selected Advantages—

Time complexity of the methods for multi-source assignment as shown and described herein is drastically improved over Simplex (or other solver) implementation. Simplex must examine every possible combination before arriving at a solution, and cannot be stopped early and have a valid solution. The need of the Simplex algorithm to examine every possible way of combining data of a multi-source assignment problem in different orders in order to arrive at a solution results in infeasibly high runtimes. Finding a solution to this assignment problem using a Simplex implementation arrives at a solution in exponential time, and may further have large memory or storage requirements. The use of methods for multi-source assignment as shown and described herein enables the system to arrive at a solution to the problem of assigning supplies from one of a set of sources to demands in linear time, with far smaller memory or storage requirements compared to the Simplex algorithm. Thus, the systems and methods for multi-source assignment arrive at solutions to the problem of assigning supplies from one of a set of sources to demands much more quickly and efficiently than was previously possible.

This comparison is based on execution of the methods for multi-source assignment as shown and described herein and for the simplex implementation using equivalent (or the same) benchmark hardware configurations. Note that in tests, the systems and methods described herein performed thousands of times faster than the Simplex method. Therefore, these improvements in speed and performance are not caused by brute force application of computing power, but by the inventive processes shown and described herein for multi-source assignment.

In experimental validation, an example multi-source assignment problem was performed by a benchmark hardware configuration for both the Simplex algorithm and one embodiment of the inventive multi-source assignment method using the “center of mass” (Flexibility Score) source selection algorithm, as discussed above. The example multi-source assignment problem included 90 days with an average of 25 demands per day per priority, with demands in four priority levels, and with supplies arriving weekly at 12 sources. The multi-source assignment method using the “center of mass” (Flexibility Score) source selection algorithm arrived at a solution in 5.7 seconds; while the Simplex algorithm had not arrived at a solution after 5 hours and 30 minutes. In another example problem, the example problem was configured as described above, but adjusted to have an average of 12 demands per day per priority (rather than 25 demands per day per priority). The multi-source assignment method using “center of mass” (Flexibility Score) source selection algorithm arrived at a solution in 2.6 seconds; while the Simplex algorithm had not arrived at a solution after 1 hour and 45 minutes. In another example problem, the example problem was configured as described above, but adjusted to have only 10 days instead of 90, and an average of 10 demands per day per priority. The multi-source assignment method using he “center of mass” (Flexibility Score) source selection algorithm arrived at a solution in 0.56 seconds; while the Simplex algorithm arrived at a solution after 20 minutes.

Experimental validation was also performed for the multi-source assignment method using other source selection algorithms, such as round robin or least supply, and the time to result using those algorithms is comparable to the time to result for the multi-source assignment method using he “center of mass” (Flexibility Score) source selection algorithm discussed above. Generally, the time to result for the multi-source assignment method described herein is exponentially faster than the Simplex algorithm, as shown by the orders of magnitude difference between time to solution for the Simplex algorithm and time to solution of the multi-source assignment method using the “center of mass” (Flexibility Score) source selection algorithm shown above.

The drastic reduction in the compute (processor) time and storage requirements enables the real-time or quasi-real-time generation of assignment solutions needed for interactive, exploratory revision of multi-source assignment configurations in a user interface. Before the introduction of the multi-source assignment systems and methods as described herein, such interactive exploration was not possible.

Also, Simplex-based systems and methods for providing a solution assigning supplies from one of a set of sources to demands can rapidly exhaust memory resources, because the memory requirements can grow factorially as the number of demands to evaluate grows linearly (due to the combinatorial nature of this problem). The multi-source assignment systems and methods described herein require far less memory resources.

Additionally, Simplex-based systems and methods for providing a solution assigning supplies from one of a set of sources to demands will provide only one ‘best’ solution, even though there may be alternative, equally good solutions that a user may want to evaluate. The multi-source assignment systems and methods described herein present, and further allow automatic selection of, alternative valid solutions.

### —Software Module Embodiments—

In general, software instructions are designed to be executed by one or more suitably programmed processors (such as CPUs or GPUs) accessing memory or storage. These software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The set of modules may be controlled or coordinated in their operation by a main program for the system, an operating system (OS), or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Cloud, Multi-Tenant, or Enterprise Embodiments—

In one embodiment, multi-source assignment system 100 is a computing/data processing system including a computing application or collection of distributed computing applications for access and use by other client computing devices associated with an enterprise that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, multi-source assignment system 100 may be implemented as a component or module of a cloud-based operations management system. In one embodiment multi-source assignment system 100 is a centralized server-side application that provides at least the functions disclosed herein and that is accessed by many users via computing devices/terminals communicating with the computers of multi-source assignment system 100 (functioning as one or more servers) over a computer network.

In one embodiment, the components of intercommunicate with each other, and with other computing system components, by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of multi-source assignment system 100 may (i) generate or compose an electronic message or signal to issue a command or request to another component, (ii) transmit the message or signal to other components of multi-source assignment system 100 (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by multi-source assignment system 100, for example through a web interface server. In one embodiment, the remote computing system may send requests to and receive responses from multi-source assignment system 100. In one example, access to the information or applications may be affected through use of a web browser on a personal computer or mobile device. In one example, communications exchanged with multi-source assignment system 100 may take the form of remote representational state transfer (REST) requests using JavaScript object notation (JSON) as the data interchange format for example, or simple object access protocol (SOAP) requests to and from XML servers. The REST or SOAP requests may include API calls to components of multi-source assignment system 100. For example, a REST or SOAP request may cause method 200 to be performed.

In one embodiment multi-source assignment system 100 may present one or more user interfaces. User interfaces may include graphical user interfaces (GUIs) and command line interfaces (CLIs) through which end users and administrators may access and use the multi-source assignment system 100 and/or other components of an operations management system. For example, through GUIs and CLIs, end users and/or administrators may provide inputs that cause method 200 to be performed.

In one embodiment, a GUI may include user-manipulable elements for inputting information or commands. Examples of GUI elements include user-selectable graphical buttons, radio buttons, menus, checkboxes, drop-down lists, scrollbars, sliders, spinners, text boxes, icons, labels, progress bars, status bars, toolbars, windows, hyperlinks, and dialog boxes. In one example, GUI elements may be selected or manipulated by a user to enter information to be parsed and used by multi-source assignment system 100. In one example, GUI elements may be manipulated or interacted with by mouse clicks, mouse drag-and-drops, cursor hovers over the element, or other operations of a cursor controller or text input device.

In one embodiment, multi-source assignment exploration tool 300 is a GUI. In one embodiment, demand icons (such as demand icon 315) and supply icons (such as supply icon 350) may be dragged and dropped within various display regions of multi-source assignment exploration tool 300. In one embodiment, demand icons may be marked as constrained to be met or constrained to remain unmet, or have no constraint, for example by clicking the demand icon to accessing a menu and selecting the constraint from the menu. In one embodiment, in response to a drag-and-drop of a supply or demand icon or a change in a constraint status of a demand icon in multi-source assignment exploration tool 300, multi-source assignment system 100 will automatically initiate multi-source assignment method 200 and re-display a new assignment solution updated to reflect the user-input changes.

### —Computing Device Embodiment—

FIG. 6 illustrates an example computing system 600 that is configured and/or programmed as a special purpose computing device with one or more of the example systems and methods described herein, and/or equivalents. In one embodiment, example computing system 600 includes an example computer or computing device 605. Example computing device 605 may include at least one hardware processor 610, a memory 615, and input/output ports 620 operably connected by a bus 625. In one example, the computer 605 may include multi-source assignment logic 630 configured to facilitate assigning supply to demand from multiple supply sources, similar to the logic, systems, and methods shown and described with reference to FIGS. 1-5.

In different examples, logic 630 may be implemented in hardware, a non-transitory computer-readable medium 637 with stored instructions, firmware, and/or combinations thereof. While logic 530 is illustrated as a hardware component attached to the bus 625, it is to be appreciated that in other embodiments, logic 630 could be implemented in the processor 610, stored in memory 615, or stored in disk 635.

In one embodiment, logic 630 or the computer is a means (that is, structure: hardware, non-transitory computer-readable medium, firmware) for performing the actions described. In some embodiments, computing device 605 may be a server operating in a cloud computing system, a server configured in a Software as a Service (SaaS) architecture, a smart phone, laptop, tablet computing device, and so on.

The means may be implemented, for example, as an ASIC programmed to assign supply to demand from multiple supply sources as shown and described herein. The means may also be implemented as stored computer executable instructions that are presented to computer 605 as data 640 that are temporarily stored in memory 615 and then executed by processor 610.

Logic 630 may also provide means (for example, hardware, non-transitory computer-readable medium that stores executable instructions, firmware) for performing assignment of supply to demand from multiple supply sources as shown and described herein.

Generally describing an example configuration of the computer 605, the processor 610 may be a variety of various processors including dual microprocessor and other multi-processor architectures. A memory 615 may include volatile memory and/or non-volatile memory. Non-volatile memory may include, for example, ROM, PROM, and so on. Volatile memory may include, for example, RAM, SRAM, DRAM, and so on.

Storage or disks 635 may be operably connected to the computer 605 via, for example, an input/output (I/O) interface (e.g., card, device) 645 and an input/output port 620 that are controlled by at least an input/output (I/O) controller 647. The storage or disk 635 may be, for example, a magnetic disk drive, a solid-state drive, a floppy disk drive, a tape drive, a Zip drive, a flash memory card, a memory stick, and so on. Furthermore, the storage or disk 635 may be a CD-ROM drive, a CD-R drive, a CD-RW drive, a DVD ROM, and so on. The memory 615 can store a process 650 (such as method 200) and/or a data 640, for example. The storage or disk 635 and/or the memory 615 can store an operating system that controls and allocates resources of the computer 605.

The computer 605 may interact with, control, and/or be controlled by input/output (I/O) devices via the input/output (I/O) controller 647, the I/O interfaces 645, and the input/output ports 620. Input/output devices may include, for example, one or more displays 670, printers 672 (such as inkjet, laser, or 3D printers), audio output devices 674 (such as speakers or headphones), text input devices 680 (such as keyboards), cursor control devices 682 for pointing and selection inputs (such as mice, trackballs, touch screens, joysticks, pointing sticks, electronic styluses, electronic pen tablets), audio input devices 684 (such as microphones or external audio players), video input devices 686 (such as video and still cameras, or external video players), image scanners 688, video cards (not shown), disks 635, network devices 660, and so on. The input/output ports 620 may include, for example, serial ports, parallel ports, and USB ports.

The computer 605 can operate in a network environment and thus may be connected to the network devices 655 via the I/O interfaces 645, and/or the I/O ports 620. Through the network devices 655, the computer 605 may interact with a network(s) 660. Through network 660, the computer 605 may be logically connected to remote computers 665. Networks with which the computer 605 may interact include, but are not limited to, a LAN, a WAN, and other networks.

In one embodiment, each step of computer-implemented methods described herein may be performed by a processor (such as processor 610) of one or more computing devices (i) accessing memory (such as memory 615) and/or other computing device components and (ii) configured with logic (such as logic 630) to cause the system to execute the step of the method. For example, the processor accesses and reads from or writes to the memory to perform the steps of the computer-implemented methods described herein. These steps may include (i) retrieving any necessary information, (ii) calculating, determining, generating, classifying, or otherwise creating any data, and (iii) storing any data calculated, determined, generated, classified, or otherwise created. References to storage or storing indicate storage as a data structure in memory or storage/disks (such as memory 615, or storage/disks 635) of a computing device or remote computer.

In one embodiment, each subsequent step of a method commences automatically in response to parsing a signal received or stored data retrieved indicating that the previous step has been performed at least to the extent necessary for the subsequent step to commence. Generally, the signal received or the stored data retrieved indicates completion of the previous step.

### Definitions and Other Embodiments

No action or function described or claimed herein is performed by the human mind. An interpretation that any action or function described or claimed herein can be performed in the human mind is inconsistent with and contrary to this disclosure.

No action or function described or claimed herein is an economic practice, commercial or legal interaction, or management of personal behavior. An interpretation that any action or function described or claimed herein is an economic practice, commercial or legal interaction, or management of personal behavior is inconsistent with and contrary to this disclosure.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure,” as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium,” as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection,” or a connection by which entities are “operably connected,” is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User,” as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both.” When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium that includes stored thereon computer-executable instructions that when executed by at least a processor of a computer cause the computer to:
sort a set of demands by size of demand;
generate a set of assignments between demands belonging to the set of demands and supplies at multiple sources, by, for the demands in ascending order of the size of demand,
(i) identifying from among the multiple sources a set of the sources that have sufficient supply to fill the demand,
(ii) choosing one source from the set of sources from which to fill the demand, and
(iii) assigning the demand to be filled from one or more supplies of the one source to form an assignment for the demand in the set of assignments; and
allocate the supplies at the multiple sources to the demands belonging to the set of demands in accordance with the set of assignments.

2. The non-transitory computer-readable medium of claim 1, wherein the instructions for the choosing the one source from the set of sources from which to fulfil the demand further cause the computer to:
determine flexibility scores for the sources in the set of sources, wherein the flexibility score for the sources are determined based on a size of the demand, a time of fulfillment for the demand, and a time of availability of supply;
identify a least-flexible source among the set of sources that has a flexibility score indicating supply closest to the time of fulfillment for the demand; and
select the least-flexible source to be the one source from which to fill the demand.

3. The non-transitory computer-readable medium of claim 2, wherein the instructions further cause the computer to:
repeat the generation of the set of assignments through multiple runs to create multiple sets of assignments until a condition is satisfied;
during a run of the multiple runs,
identify multiple least-flexible sources having equal flexibility scores, wherein the least flexible source is included in the multiple least flexible sources, and
select from among the multiple least-flexible sources at random to select the least-flexible source to be the one source; and
select a one of the multiple sets of assignments to be the set of assignments, wherein the one of the multiple sets of assignments has a least number of unfilled demands.

4. The non-transitory computer-readable medium of claim 2, wherein the instructions to select the least-flexible source further cause the computer to select the least-flexible source at random from among multiple sources having equal flexibility scores.

5. The non-transitory computer-readable medium of claim 1, wherein the instructions for the choosing one source from the set of sources from which to fulfil the demand further cause the computer to:
identify a least-supply source among the set of sources that will be left with a least amount of total supply upon fulfillment of the demand; and
select the least-supply source to be the one source from which to fill the demand.

6. The non-transitory computer-readable medium of claim 1, wherein the instructions for the choosing one source from the set of sources from which to fulfil the demand further cause the computer to:
identify a next source in a cycle though the multiple sources, wherein the next source is also in the set of sources from which the demand can be filled; and
select the next source to be the one source from which to fill the demand.

7. The non-transitory computer-readable medium of claim 1, wherein the instructions further cause the computer to exclude from the set of demands those demands that are constrained to be unmet.

8. The non-transitory computer-readable medium of claim 1, wherein the instructions further cause the computer to fill all demands in the set of demands that are constrained to be met.

9. The non-transitory computer-readable medium of claim 1, wherein the instructions further cause the computer to:
present a user interface including an option to enter an input that adds, removes, or changes parameters of the demands or supplies;
accept the input, wherein the generation of the set of assignments is performed in real-time in response to accepting the input;
display information showing the fulfillment status of the demands based on the assignments between demands and supplies; and
present a user-selectable option to fill the demands belonging to the set in accordance with the assignments between demands and supplies, wherein the transmitting the instruction is performed in response to selection of the user-selectable option.

10. A computing system, comprising:
a processor;
a memory operably connected to the processor;
a non-transitory computer-readable medium operably connected to the processor, wherein the non-transitory computer-readable medium includes stored thereon computer-executable instructions that when executed by at least the processor of the computing system cause the computing system to:
sort a set of demands by size of demand;
generate a set of assignments between demands belonging to the set of demands and supplies at multiple sources, by, for the demands in ascending order of the size of demand,
(i) identifying from among the multiple sources a set of the sources from which a demand can be filled,
(ii) choosing one source from the set of sources from which to fill the demand, and
(iii) assigning the demand to be filled from one or more supplies of the one source to form an assignment for the demand in the set of assignments; and
transmit an instruction to allocate the supplies at the multiple sources to the demands belonging to the set of demands in accordance with the set of assignments.

11. The computing system of claim 10, wherein the instructions for the choosing the one source from the set of sources from which to fulfil the demand further cause the computing system to:
determine flexibility scores for the sources in the set of sources;
identify a least-flexible source among the set of sources based on the flexibility score for the least flexible source; and
select the least-flexible source to be the one source from which to fill the demand.

12. The computing system of claim 11, wherein the instructions to select the least-flexible source further cause the computing system to select the least-flexible source at random from among multiple sources having equal flexibility scores.

13. The computing system of claim 10, wherein the instructions for the choosing one source from the set of sources from which to fulfil the demand further cause the computing system to select as the one source from which to fill the demand one of:
a source that will be left with a least amount total supply upon fulfillment of the demand;
a source that is next in a cycle though the multiple sources; or
a random source.

14. The computing system of claim 10, wherein the instructions for identifying from among multiple sources the set of sources from which a demand can be filled further cause the computing system to compare a time of fulfillment of the demand and a time of availability of supply for one of the sources belonging to the set.

15. The computing system of claim 10, wherein the instructions further cause the computing system to:
present a user interface including an option to enter an input that adds, removes, or changes parameters of the demands or supplies;
accept the input, wherein the generation of the set of assignments is performed in real-time in response to accepting the input;
display information showing the fulfillment status of the demands based on the assignments between demands and supplies; and
present a user-selectable option to fill the demands belonging to the set in accordance with the assignments between demands and supplies, wherein the transmitting the instruction is performed in response to selection of the user-selectable option.

16. A computer-implemented method, comprising:
sorting a set of demands by size of demand;
generating a set of assignments between demands belonging to the set of demands and supplies at multiple sources, by, for the demands in ascending order of the size of demand,
(i) identifying from among the multiple sources a set of the sources from which a demand can be filled,
(ii) choosing one source from the set of sources from which to fill the demand, and
(iii) assigning the demand to be filled from one or more supplies of the one source to form an assignment for the demand in the set of assignments; and
allocating the supplies to the demands belonging to the set of demands in accordance with the set of assignments.

17. The computer-implemented method of claim 16, wherein the choosing the one source from the set of sources from which to fulfil the demand further comprises:
determining flexibility scores for the sources in the set of sources, wherein the flexibility score is determined based on the size of the demand, a time of fulfillment for the demand, and a time of availability of supply for the source;
identifying one or more least-flexible sources among the set of sources that have a flexibility score indicating supply closest to the time of fulfillment for the demand; and
selecting a random one of the least-flexible sources to be the one source from which to fill the demand.

18. The computer-implemented method of claim 16, wherein the choosing the one source from the set of sources from which to fulfil the demand further comprises selecting as the one source from which to fill the demand one of:
a source that will be left with a least amount total supply upon fulfillment of the demand;
a source that is next in a cycle though the multiple sources; or
a random source.

19. The computer-implemented method of claim 16, further comprising:
excluding from the set of demands those demands that are constrained to be unmet; and
filling all demands in the set of demands that are constrained to be met.

20. The computer-implemented method of claim 16, further comprising subdividing the set of demands by level of a priority, wherein the generating the set of assignments is performed for demands having a superior priority level before the generating the set of assignments is performed for demands having an inferior priority level.
